(19) United States
(12) Patent Application Publication
(10) Pub. No.: US 2001/0028949 A1
(43) Pub. Date: Oct. 11, 2001

(54) Process for producing injection molded products

(76) Inventors: Yoshiaki Togawa, Kyoto-shi (JP); Toshitsugu Kikuchi, Ichihara-shi (JP); Shinichi Nagaoka, Ichihara-shi (JP)

Correspondence Address: SUGHRUE, MION, ZINN, MACPEAK & SEAS, 2100 Pennsylvania Avenue, N.W., Washington, DC, 20037-3202, US

(21) Appl. No.: 09/771,627

(22) Filed: Jan. 30, 2001

(30) Foreign Application Priority Data
Jan. 31, 2000 (JP) 2000-022729
Mar. 31, 2000 (JP) 2000-097172

(51) Int. Cl. B32B 27/04

(52) U.S. Cl. 428/297.4; 264/328.8; 428/299.4

(57) ABSTRACT

In producing an injection molded product by making a molten material flow from a cylinder through a plurality of gates in a die into a cavity and thereby filling the cavity with the molten material, a part of the flows of the molten material coming from a part of the gates is decreased or stopped before the flows of the molten material coming from a plurality of gate attain confluence in the cavity, and the flows of the molten material are made confluent by the flowing action of the flow(s) of the molten material coming from residual gate(s). According to the process of the present invention, the problem of mechanical properties in the injection molded products can be solved without adding any new apparatus to a general-purpose injection molding machine.

### BACKGROUND OF THE INVENTION

The present invention relates to a process for producing injection molded products, and particularly to a process by which the mechanical properties of the weld part of an injection molded product can be improved.

The present invention further relates to an injection molded product having one weld part or a plurality of weld parts and improved in the mechanical properties of the weld parts(s).

It has widely been known hitherto in the injection molding process that, when the molten material flows come from a plurality of gates and become flowing together, there is formed a weld part at the point of confluence. Since in such a weld part the flows of the molten material are along the plane of confluence, mechanical properties such as mechanical strength decreases, and especially in the molded products of inorganic material-filled composite materials or glass fiber-reinforced resins, the deterioration in mechanical strength at the confluence part is remarkable. Thus, there has been a problem that the weld part of an injection molded product cannot exhibit the mechanical properties which the material itself has originally.

In view of above, various attempts have been made so far with the aim of solving the problem of mechanical properties at the weld part and proposed in, for instance, JP A 48-71459, JP A 63-221023, JP B 4-3893, JP A 9-1611, JP A 4-310715, etc. In these documents, it is proposed to provide an additional apparatus such as folded plate, boss, stagnant resin part, SCORIM unit and the like to promote a flow of a material in the weld part after formation of the weld part, and it is mentioned that thereby the weld part can be strengthened.

In JP A 10-211635, it is mentioned that a weld part can be strengthened by using a die in which the lengths from the first branch point of runner to the gates are uneven and keeping the inner pressure of a cavity constant.

### SUMMARY OF THE INVENTION

Indeed, strength of the weld part can be improved to some extent according to the methods mentioned above. However, the methods of these documents require to use a special apparatus additionally, and the method of JP A 10-211635 has a problem that the positions of gates are restricted. Accordingly, it is desired to develop a new process for producing an injection molded product which requires no additional apparatus, makes it possible to carry out injection molding by an easy and simple procedure, has no restriction in the structure of die, and has a high degree of freedom about the molding process.

The present invention has been invented based on the above-mentioned desire, and an object of the present invention consists in providing a process for producing an injection molded product by which the problem of mechanical properties of the weld part in the injection molded product can be solved without adding any new apparatus to the general-purpose injection molding machine nor restricting the process.

Another object of the present invention consists in providing an injection molded product which exhibits the mechanical properties of the used material itself even in the weld part of the injection molded product.

According to the present invention, the objects mentioned above can be achieved by using a process for producing an injection molded product by making flow a molten material from a cylinder through a plurality of gates provided in a die into a cavity and thereby filling the cavity, which comprises decreasing or stopping a flow(s) of the molten material coming from a part of the gates before flows of the molten material coming from a plurality of gates attain confluence in the cavity, and making confluent the decreased or stopped flow(s) and a flow(s) of the molten material coming from the residual gate(s)

Thus, the process of the present invention is characterized by merely carrying out the operations of decreasing or stopping the flow(s) of the molten material flowing from a part of the gates before the molten material flows coming from a plurality of gates become combined together in the cavity, and making confluent the molten material flows by the flowing action of the molten material coming from the residual gate(s). Accordingly, there is no necessity of adding an additional apparatus to prior injection molding machine nor restricting the procedure additionally, and the process of the invention can provide an injection molded product improved in the mechanical properties in the weld part by an easy and simple control.

### BRIEF DESCRIPTION OF THE DRAWING

FIG. 1 is an outlined sectional view of the injection molding machine of the present invention.

FIG. 2 is a schematic view illustrating the state of confluence of a molten material in the present invention in order.

FIG. 3 is a schematic view illustrating the state of confluence of a molten material in the prior art in order.

FIG. 4 is a schematic view illustrating the state of confluence of a molten material in order, in a case where the number of gates is 3.

FIG. 5 is a schematic view illustrating the state of confluence of a molten material in order, in a case where the number of gates is 3.

FIG. 6 is a schematic view illustrating the state of confluence of a molten material in order, in a case where the number of gates is 4.

FIG. 7 is an outlined view illustrating the method for measuring impact strengths.

FIG. 8 is an explanatory view illustrating the operating conditions of channel switches in the injection molding process of the present invention.

FIG. 9 is an explanatory view illustrating the operating conditions of channel switches in the injection molding process of the present invention.

FIG. 10 is an explanatory view illustrating the operating conditions of channel switches in the injection molding process according to prior art.

FIG. 11 is an explanatory view illustrating the operating conditions of channel switches in the injection molding process according to prior art.

FIG. 12 is an explanatory view illustrating the operating conditions of channel switches in the injection molding process for obtaining an injection molded product having no weld part.

FIG. 13 is an outlined view schematically illustrating the notch part of a test piece for measurement of impact strength in an injection molded product having a weld part.

FIG. 14 is an outlined view illustrating a test piece of an injection molded product at the time of measurement of impact strength.

FIG. 15 is an outlined view schematically illustrating the notch part of a test piece for measurement of impact strength in an injection molded product having no weld part.

### DETAILED DESCRIPTION OF THE INVENTION

Next, the present invention will be explained in more detail. The process of the present invention for producing an injection molded product is a process for producing an injection molded product by making a molten material flow into a cavity from a cylinder through a plurality of gates provided in a die and thereby filling the cavity with the molten material, characterized by decreasing or stopping the flow(s) of the molten material coming from a part of gates before the flows of the molten material coming from a plurality of gates attain confluence in the cavity, and making confluent the decreased or stopped flow(s) and the flow(s) of the molten material coming from the residual gate(s).

The process for producing an injection molded product according to the present invention is applicable to any of the hitherto known injection molding processes, and the apparatus used herein may be a generally used apparatus so far as it is provided with a means for decreasing or stopping the flow(s) of the molten material coming from a part of gates before the flows of the molten material coming from a plurality of gates become confluent in the cavity and making confluent the molten material flows by the flowing action of the flow(s) of the molten material coming from the residual gate(s). In the present invention, it is preferred that the flow(s) of the molten material coming from a part of the gates is stopped.

For instance, in the case of a die having a hot runner, the flows of molten material in the cavity may be controlled by adjusting the timing of switching of the shut-off valve. In the case of a die having a cold runner, it is enough to provide a channel switch in the gate part or in the upstream runner part to control the flows of the molten material by adjusting the timing of switching thereof.

As used herein, the term “injection molding” widely means general injection moldings, which include injection press molding, injection compression molding, foam-injection molding, etc., too.

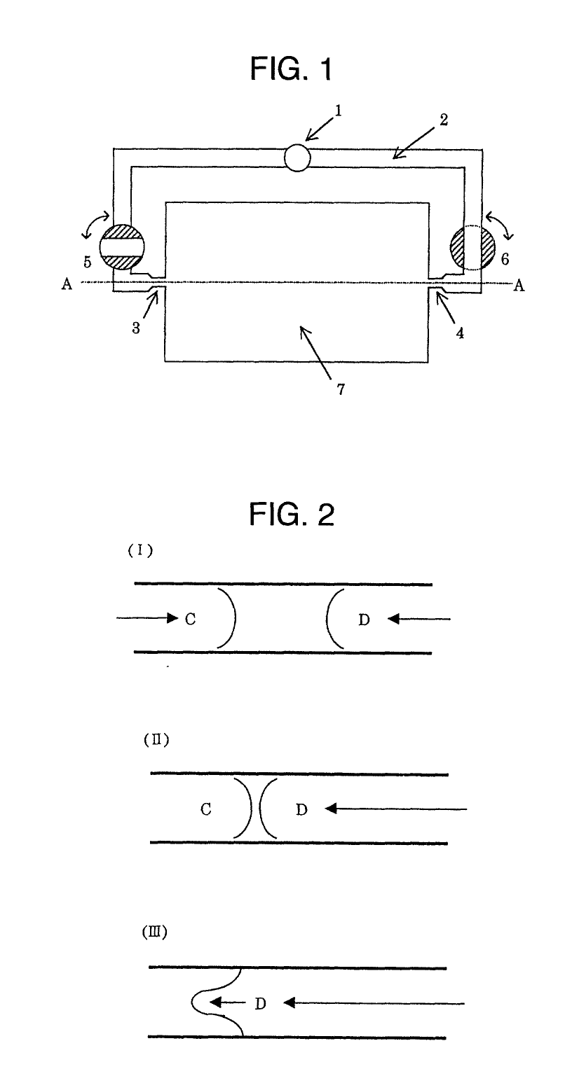

A concrete procedure thereof will be explained by referring to FIG. 1. FIG. 1 is an outlined sectional view of an injection molding machine, which has a sprue part 1 connected to a nozzle part of a cylinder, a molten material channel 2, a plurality of gates 3 and 4, channel switches 5 and 6, and a cavity part 7.

In the present invention, the cylinder used is not particularly limited, though a single cylinder is preferable.

Gates 3 and 4 are not particularly limited, so far as a plurality of gates are present. Three-points gate, and gates of 4 or more points are also usable. In the present invention, the number of gates is preferably 3 or more, because of easiness of controlling the injection molding process. The structure of channel switches 5 and 6 is not particularly limited, so far as the flows of the molten material can be controlled properly. In the present invention, the flows of the molten material can be decreased or stopped by closing the gate part or its upstream flow channel of the molten material. Further, it is preferred that the flow(s) of the molten material is decreased or stopped by closing a valve.

As the specific operations, the following can be referred to, though they are not limitative. Thus, (1) a process which comprises, in a state that both channel switches 5 and 6 are open, making flow the molten material injected from a cylinder through the sprue part 1 into the cavity 7 via the molten material channel 2 and the gates 3 and 4 and thereafter, at a stage when the flows do not yet attain a state of confluence, closing one of the channels to stop the molten material flow by operating the channel switches 5 or 6, continuing the flow from the unclosed channel and thereby making the flows of the molten material confluent; and (2) a process which comprises, in a state that channel switch 6 is closed and only channel switch 5 is open, making flow a molten material injected from a cylinder through the sprue part 1 into the cavity 7 through the molten material channel 2 and then through the gate 3, and thereafter, in a prescribed state that the molten material flows do not yet attain confluence, closing the open channel switch 5 to stop the flow of the molten material from the gate 3 and opening the closed channel switch 6 to make the molten material flow from the gate 4 and thereby making the flows of the molten material confluent; etc.

Needless to say, a method reverse to the above-mentioned process (2), namely a process of making flow the molten material in a state that the channel switch 5 is closed and the channel switch 6 is open, then closing the channel switch 6 to stop the flow of the molten material from the gate 4, and opening the channel switch 5 to make the molten material flow from the gate 3, and thereby making the flows of the molten material confluent is also possible.

In a case where the number of gates is 3 or more, the molten material may be made to flow into the cavity from all the gates simultaneously, or it is also possible to make flow the molten material from individual gates with time differences. When the gate or its upstream channel is to be closed, a plurality of channels may be closed simultaneously, or individual gates or channels may be closed with time differences.

The time when the flow(s) of the molten material coming from a part of the gates is decreased or stopped may vary depending on the material to be injection molded, the apparatus, the conditions of injection molding, etc. It can be decided by repeating short shots previously to determine the confluence time of the molten material in the injection molding process.

It is also possible to adjust the pressure of the continuously flowing molten material after decreasing or stopping the flow(s) of the molten material coming from a part of the gates. When the pressure is elevated, the flowing molten material comes to penetrate the decreased or stopped flow(s) of the molten material more deeply.

Next, one example of the expected state of confluence of the molten material according to the present invention will be mentioned by referring to FIG. 2. In FIG. 2, the confluence of molten material flows in the cavity 7 in FIG. 1 is viewed from section A-A, where it is seen that confluence of molten material flows progresses in order of (I), (II) and (III). In the process of the present invention, one of the molten material flows (in this case, C) is stopped before the flows of the molten material C and D are combined together in the cavity, so that the molten material C is not supplied further, and its flow stops. On the other hand, the other molten material D still continues flowing, as a result of which the flows of the molten material C and D approach each other and become confluent as expressed by (I) and (II) in FIG. 2. When the molten material D becomes confluent with the head part of the molten material C, the molten material D enters the molten material C due to the pressure difference between them, and there is formed a wedge of the molten material D driven into the molten material C (see (III) of FIG. 2). It is considered that, according to the present invention, the problems arising in the weld part in the prior art can be solved by appearance of such a state.

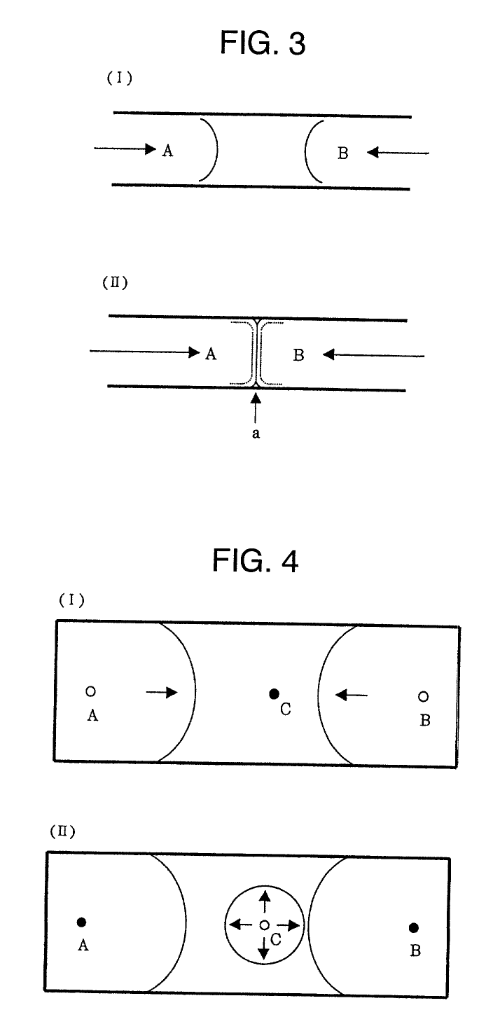

On the contrary, FIG. 3 expresses the state of confluence of a molten material in the prior art, wherein the state of confluence is viewed from the section A-A in the same manner as in FIG. 2. According to the prior process, both the molten materials A and B are continuously supplied. Thus, even if the two flows become confluent at a certain point (the position of a) in the cavity, any of the flows cannot enter the other because both the flows are equal in pressure, so that both the flows are separately oriented along the plane of confluence to form a weld part at the position a (see (II) of FIG. 3).

In JP A 2-202414, there is disclosed a process for strengthening the fusion-bonded part which comprises, after the resin flows coming from a plurality of gates have been combined together and integrated, carrying out a gate operation to realize differences in packing pressure between a plurality of resin flows, due to which one of the resin flows is pressed into other flows to reinforce the fusion-bonded part.

However, this process is disadvantageous in that the confluence and integration of resin flows cannot readily be certified when the apparatus has three or more gates, and since the confluence and integration of resin flows do not take place simultaneously on all the resin flows, it is difficult to improve the strengths of all weld parts simultaneously. In turn, in the process of differentiating the packing pressures of resin flows after confluence and integration of resin flows, it is difficult to give a sufficient flow to the weld parts enough to disturb the orientation of resins in the weld part, so that its effect has a limitation and improvement in mechanical properties cannot be said to be sufficient.

On the other hand, the process of the present invention requires only to decrease or stop the flow(s) of the molten material coming from a part of gates before the flows of the molten material coming from a plurality of gates attain confluence in the cavity and thereby to make confluent the molten material flows by the flowing action of the molten material flow(s) coming from the residual gate(s). Further, even when the apparatus has many gates as in the case of apparatuses having three or more gates, strengths of all the weld parts can be enhanced sufficiently.

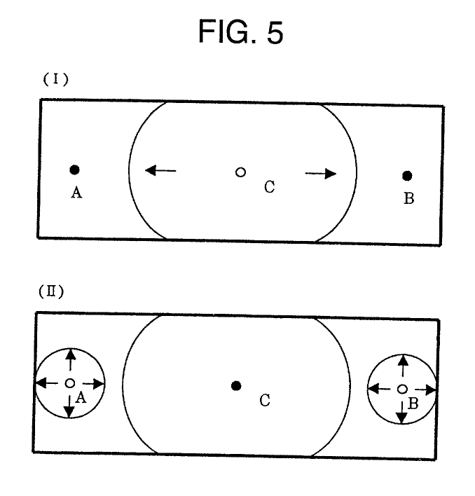

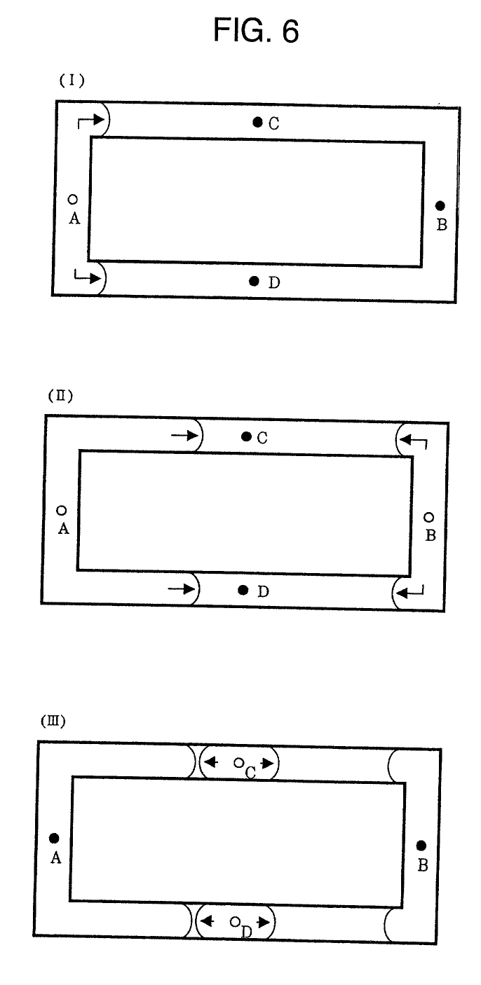

That is, when an apparatus having three or four gates is used in the present invention, the molten material are flown in such an order as shown in FIGS. 4 to 6, for instance. Herein, A, B, C in FIGS. 4, 5 and A, B, C, D in FIG. 6 respectively represents a gate, wherein the mark ◯ represents an open gate and the mark ● represents a closed gate. Even when the apparatus has many gates and the molten material flows in a complicated manner, the flow(s) of one molten material is stopped prior to the confluence, so that the process of the present invention can realize the pressing of the flowing molten material into the decreased or stopped flow(s) of the molten material at any of the confluence points certainly. Accordingly, the present invention makes it possible to enhance the strengths of all the weld parts sufficiently.

In the process of the present invention, the flow(s) of the molten material coming from a part of gates is decreased or stopped before the confluence of the molten material flows, which brings about a decrease in material pressure in the cavity and therefore a great effect of decreasing the clamping force. Further, according to this process, it is possible to shift a weld part to a desired position regardless of the arrangement of gates. In this case, the time of switching of channels can easily be known from a flow analysis, for instance.

As has been mentioned above, the strength of the weld part can be improved by using the production process of the present invention. Further, according to the present invention, it is also possible to obtain a new injection molded product in which the impact strength of the weld part is equal to or higher than the impact strength of non-weld part. Such an injection molded product has not been thought of at all, up to date.

That is to say, the injection molded product of the present invention is an injection molded product made of one material and having one or a plurality of weld parts, in which the ratio (impact strength in the weld part)/(impact strength in the non-weld part) is preferably 0.95 or more, further preferably 1.00 or more, yet further preferably 1.05 or more, and most preferably 1.10 or more. Although the upper limit of the impact strength ratio is not particularly critical, said upper limit is preferably 2 and further preferably 1.5 and most preferably 1.2, based on a thought that an injection molded product cannot get a much increased merit even if the ratio (impact strength in the weld part)/(impact strength in the non-weld part) exceeds 2.

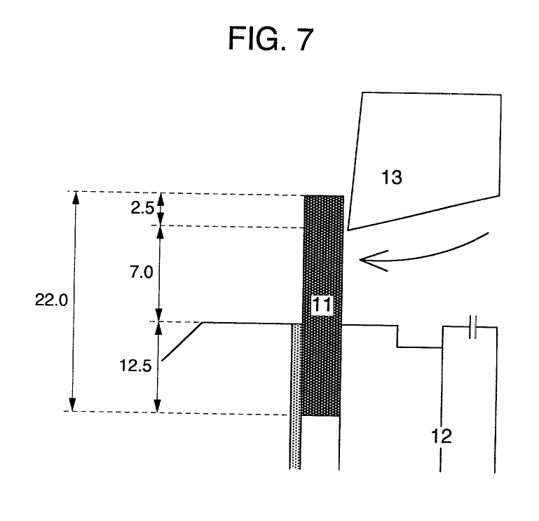

As used in the present invention, the term “impact strength” can be defined as a resistance to deformation and breakage of an injection molded product, namely an energy per unit area required for breakage, which can be measured with, for instance, the conventional Dynstat impact testing machine (DIN 53453). Herein, the Dynstat impact strength test is carried out according to the procedure prescribed in DIN 53453. More concretely speaking, as shown in FIG. 7, a test piece 11 having a size of 10 mm (width)×22 mm (length)×3 mm (thickness) is fixed with a chuck 12 so that the end of the chuck comes to a position 12.5 mm distant from the lower end of the test piece 11, and a position 7.0 mm distant from the chuck end is struck with an impactor 13 of a hammer in the direction of thickness (the temperature of test is 23° C.). The energy required for breakage of test piece [kJ/m²] is calculated from difference between the initial lifting angle of the hammer and the rising angle of the hammer after breakage of the test piece, from which impact strength is determined. A material having a higher impact resistance shows a higher impact strength. The term “impact strength of weld part” means an impact strength exhibited when the test piece is struck in a direction parallel to the weld line.

Subsequently, the material constituting the molded product of the present invention will be described. The present invention is not particularly limited in the component material, but all the materials which have been used hitherto in injection molding processes can be used without problem. However, thermoplastic resins are preferably used as the molding material. Unless the object of the present invention is damaged, one or more conventional additives may be added to the resin component. Said conventional additives include fibrous reinforcing materials such as glass fiber, silica-alumina fiber, alumina fiber, carbon fiber, organic fibers of vegetable origins such as flax and kenaf, synthetic fibers and the like; needle-like reinforcing materials such as an aluminum borate whisker, a potassium titanate whisker and the like; inorganic fillers such as glass beads, talc, mica, graphite, wollastonite, dolomite and the like; mold release agents such as a fluororesin, metallic soap and the like; colorants such as dye, pigment and the like; antioxidants; heat stabilizers; ultraviolet absorbers; antistatic agents; surfactants, etc.

The thermoplastic resins which can be used in the present invention involve all the materials called thermoplastic resins generally, which may be any of, for instance, an amorphous polymer, a semi-crystalline polymer, a crystalline polymer, a liquid crystal polymer, and the like. Said thermoplastic resin may be a single material or a blended product of a plurality of polymer components.

Specifically speaking, the thermoplastic resins include polyolefin resins such as low-density polyethylene, high-density polyethylene, polypropylene type resins, an ethylene-propylene copolymer and the like; styrene type resins such as polystyrene, high-impact polystyrene, an ABS resin and the like; acrylic resins such as polymethyl methacrylate and the like; polyester type resins such as polyethylene terephthalate, polybutylene terephthalate and the like; polycarbonate type resins such as polycarbonate, modified polycarbonate and the like; polyamide type resins such as polyamide 66, polyamide 6, polyamide 46 and the like; polyacetal resins such as a polyoxymethylene copolymer, a polyoxymethylene homopolymer and the like; engineering plastics and super-engineering plastics such as polyether-sulfone, polyether-imide, thermoplastic polyimide, polyether-ketone, polyether-ether-ketone, polyphenylene sulfide and the like; cellulose derivatives such as cellulose acetate, cellulose acetate butyrate, ethyl cellulose and the like; liquid crystal type polymers such as a liquid crystal polymer, a liquid crystal aromatic polyester and the like; and thermoplastic elastomers such as a thermoplastic urethane elastomer, a thermoplastic styrene-butadiene elastomer, a thermoplastic polyolefin elastomer, a thermoplastic polyester elastomer, a thermoplastic vinyl chloride elastomer, a thermoplastic polyamide elastomer and the like.

The process of the present invention is successfully applicable to materials showing a remarkable deterioration in strength in the weld part. As has been mentioned above, in the usual injection molding process of the thermoplastic resin containing reinforcing material(s), the reinforcing material is oriented along the confluence plane of resins so as to face each other across the weld part, so that the strength achievable at the weld part is markedly lower than that in other parts. Especially, in molded products into which long fiber type fillers having a mean fiber length of 3 mm or more are compounded, the fibers are strongly oriented and the deterioration in weld strength is an important problem. Accordingly, the process of the present invention is very effectively applicable to the materials showing a marked deterioration in weld strength, namely thermoplastic resin materials into which a reinforcing material is compounded.

As the thermoplastic resin in such thermo-plastic resin materials into which a reinforcing material is compounded, propylene type resins and polyamide type resins are preferred.

As used herein, the term “propylene type resins” means thermoplastic propylene polymers having an isotactic polypropylene crystal structure, which are thermoplastic propylene polymer resins containing a repeating unit derived from propylene in an amount of 50% by weight or more. Among such resins, preferred are one member and mixtures of two or more members selected from the group consisting of a homopolymer of propylene, a copolymer formed between propylene and α-olefin having 2 to 10 carbon atoms (propylene is excepted) and a copolymer formed between propylene and at least one other monomers. As examples of said olefin, ethylene, butene-1, 4-methylpentene-1, hexene-1, octene-1 and decene-1 can be referred to. As the “other monomer” usable for copolymerization with propylene, conjugated dienes such as butadiene and isoprene can be referred to. Among the above-mentioned propylene type resins, preferably usable are one member and mixtures of two or members selected from the group consisting of a homopolymer of propylene and a copolymer formed between propylene and at least one α-olefins having 2 to 10 carbon atoms (propylene is excepted) such as ethylene, butene-1, hexene-1 and the like.

As the reinforcing material used in such thermoplastic resins into which an reinforcing material is compounded, glass fiber is preferred, and glass fiber having a mean fiber length of 3-50 mm is further preferred.

In the molding processes of materials comprising a liquid crystal polymer or a crystalline thermoplastic resin as a main component, there occurs an orientation of resin along the weld part, and therefore the same problem as above is apt to arise. Accordingly, the process of the present invention is very effectively applicable also to the molding processes of thermotropic liquid crystal polymers such as thermotropic liquid crystalline polyester resin and the like into which glass fiber is compounded.

As is apparent from the explanation presented above, the process of the present invention consists in a prior process for producing an injection molded product wherein the flow(s) of the molten material coming from a part of the gates is decreased or stopped before the flows of the molten material coming from a plurality of gates attain confluence in the cavity, and the flows of the molten material are brought into confluence by the flowing action of the flow(s) of the molten materials coming from the residual gate(s). Accordingly, there is entirely no necessity of adding an additional apparatus nor restricting the process as compared with the prior injection molding process.

The operation of decreasing or stopping the flow(s) of the molten material coming from a part of the gates before the flows of the molten material coming from a plurality of gates attain confluence in the cavity can be effected only by working the channel switch provided in the gate part or its upstream part. Further, since the time of closing a part of channels is not critical, it is unnecessary to monitor the flows of the molten material. Accordingly, the present invention can provide an injection molded product by an easy and simple procedure.

Further, according to the process of the present invention, a continuously flowing molten material is pressed into a molten material of which flowing action has been decreased or stopped, due to which the area of fusion-bonding between the two molten material flows is very large and, in addition, orientation of the molten materials is disturbed. As its result, the problem of mechanical property in the weld part is solved. At the same time, there is obtained an injection molded material having a good surface state (smoothness) in the weld part. Furthermore, according to the present invention, the clamping force at the time of molding can be decreased.

As has been mentioned above, according to the present invention, an injection molded product excellent in mechanical properties can be obtained by an easy and simple control without adding any new apparatus to the prior injection molding apparatus and without adding any new restriction to the prior injection molding process. Accordingly, the process of the present invention is successfully applicable to processes for producing large-sized products which must have a high mechanical strength, such as automotive parts, materials for civil engineering and construction works, miscellaneous goods, etc.

Further, the injection molded product obtained according to the process of the present invention is improved in the strength in the weld part, and the ratio (impact strength in weld part)/(impact strength in non-weld part) can be so high as 0.95 or more, which makes it possible to exhibit the original characteristic properties of the material itself used in the injection molding process in the same manner even in the weld part as in the non-weld part. This makes it unnecessary to control the process of injection molding so that the weld part comes to a position where the problem of impact strength is not important. Further, since the injection molded product obtained according to the present invention has an excellent strength in any parts thereof, the process of the present invention can produce products having a variety of shapes.

### DESCRIPTION OF PREFERRED EMBODIMENTS

Next, examples of the present invention are presented below. The present invention is by no means limited by these examples.

### Production of Injection Molded Product

[Example 1]

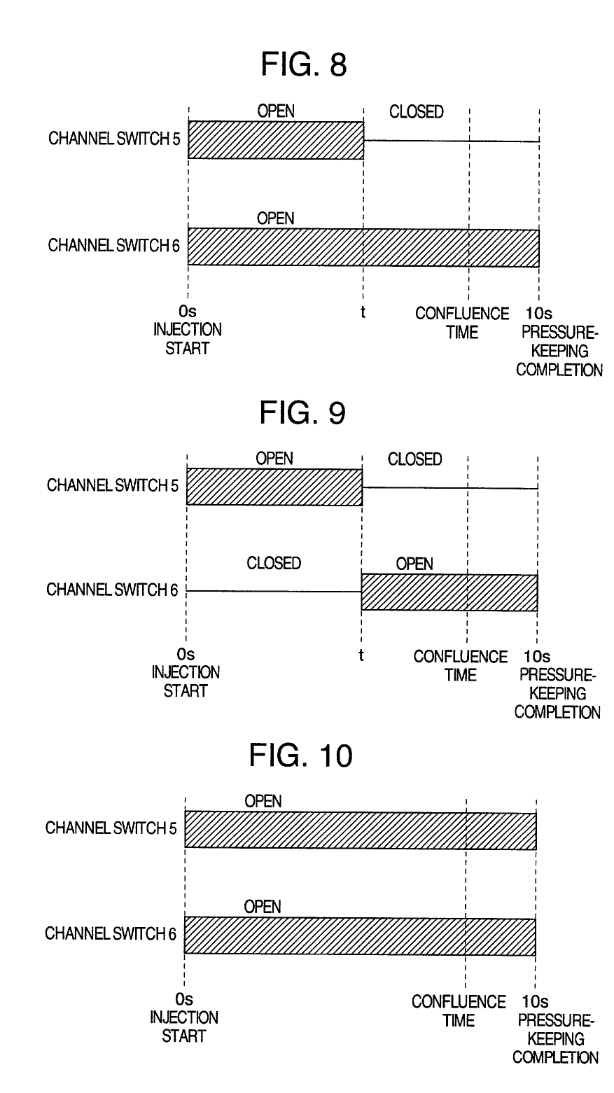

Using an injection molding apparatus shown in FIG. 1 (FS160ASEN, manufactured by Nissei Resin Industry Co., Ltd.; only the A side cylinder having a screw diameter of 50 mm was used; the cavity had a platy form, width 90 mm×length 150 mm×thickness 3 mm), the channel switches 5 and 6 were operated under the conditions shown in FIG. 8. As the molding material, the following four kinds of materials were used: (A) glass long fiber-reinforced polypropylene (manufactured by Sumitomo Chemical Co., Ltd., trade name “SUMISTRAN PG4003”, glass fiber content 40% by weight, pellet length 9 mm, glass fiber length 9 mm); (B) polypropylene (manufactured by Sumitomo Chemical Co., Ltd., trade name “SUMITOMO NOBLEN AW 564”, MFR measured at 230° C. under a load of 2.16 kg=9.0 g/10 minutes); (C) talc-containing polypropylene (manufactured by Sumitomo Chemical Co., Ltd.; trade name “SUMITOMO NOBLEN BWH44”, talc content 40% by weight; MFR measured at 230° C. under a load of 2.16 kg=9.0 g/10 minutes); (D) thermotropic liquid crystalline polyester resin (manufactured by Sumitomo Chemical Co., Ltd.; trade name “Sumikasuper LCP E7006L”, glass fiber content 30% by weight). Resin temperatures and die temperatures in the injection molding processes of these molding materials were adjusted as shown in Table 1.

Prior to production of the injection molded products, short shots were repeated several times while varying the injection time, to determine the period of time in which the molding materials coming from gates 3 and 4 attain confluence (confluence time). Guided by the results of the short shots, the time of operating the channel switches 5 and 6 (“t” in FIG. 8) was preset. The confluence time and the time of operating the channel switches 5 and 6 are also shown in Table 1.

TABLE 1

| | | | Time of | |
|---|---|---|---|---|
| | | | operating | |
| | Resin | Die | channel | |
| Molding | temperature | temperature | switches | Confluence |
| material | (° C.) | (° C.) | (seconds) | time (seconds) |
| A | 230 | 50 | 2.2 | 3.8 |
| B | 230 | 50 | 2.2 | 3.5 |
| C | 230 | 50 | 2.2 | 3.5 |
| D | 320 | 80 | 1.6 | 2.8 |

[Example 2]

Injection molded products were formed in accordance with Example 1, except that the channel switches 5 and 6 were operated under the conditions shown in FIG. 9, and the time of operation of channel switches 5 and 6 “t” was present as shown in Table 2.

TABLE 2

| Molding | Time of operating | Confluence |
|---|---|---|
| material | channel switches (seconds) | time (seconds) |
| A | 2.2 | 3.8 |
| B | 2.2 | 3.5 |
| C | 2.2 | 3.5 |
| D | 1.5 | 2.8 |

[Comparative Example 1]

Injection molded products were formed in accordance with Example 1, except that the channel switches 5 and 6 were operated under the conditions shown in FIG. 10.

[Comparative Example 2]

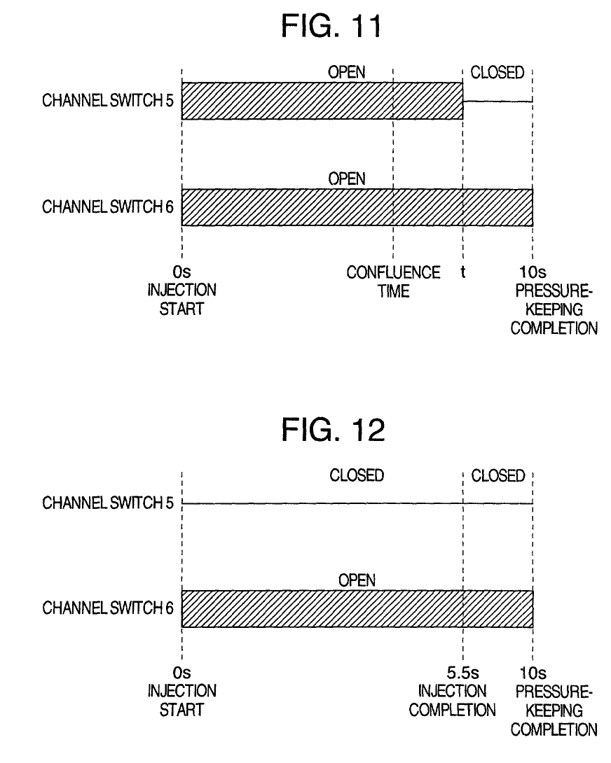

Injection molded products were formed in accordance with Example 1, except that the channel switches were operated under the conditions shown in FIG. 11, and the time of operating the channel switch 5 “t” was preset as shown in Table 3.

TABLE 3

| Molding | Time of operation of | Confluence |
|---|---|---|
| material | channel switch (seconds) | time (seconds) |
| A | 5.5 | 3.8 |
| B | 5.0 | 3.5 |
| C | 5.5 | 3.5 |
| D | 5.0 | 2.8 |

[Referential Example 1]

Injection molded products were formed in accordance with Example 1, except that the channel switches 5 and 6 were operated under the conditions shown in FIG. 12. As the molding material, only molding material (A) was used. Since the injection molded products thus obtained had no weld part, these products were used as a sample of impact strength measurement in the non-weld part of injection molded product.

### Evaluation of Physical Properties of Injection Molded Products

Impact strengths of the injection molded products obtained in Examples 1 and 2, Comparative Examples 1 and 2, and Referential Example 1 were measured according to DIN 53453.

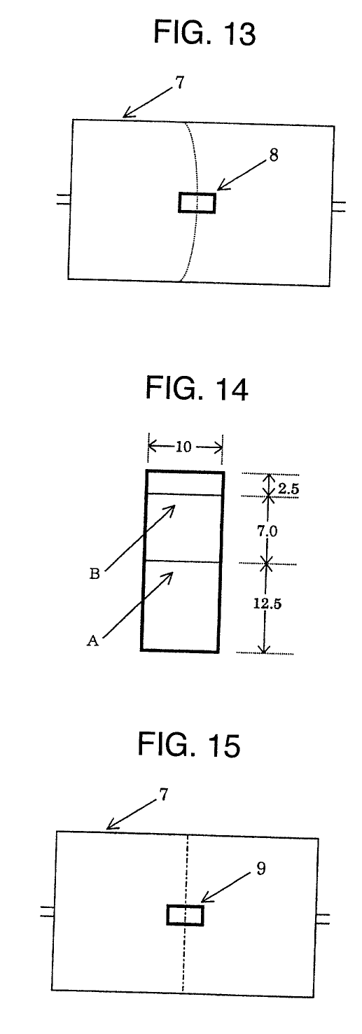

Concretely, test piece 8 was cut out from the molded product thus obtained so that the test piece had a size of 10 mm×22 mm×3 mm and its weld part (A of FIG. 14) was found at a position 12.5 mm distant from the lower end of the test piece as shown in FIGS. 13 and 14. Since the injection molded product of Referential Example 1 had no weld part, the central part of the resulting molded product having a size of 10 mm×22 mm×3 mm (the area enveloped by the one-dotted broken line) was cut out as shown in FIG. 15, to prepare test piece 9. In FIG. 13, the dotted line expresses a weld line, which is nothing but a schematic representation of the cut-out part, and it is no specific expression of weld line in each test piece.

Then, on each of the test pieces of Examples 1, 2 and Comparative Examples 1, 2, the whole area under the weld line, having a length of 12.5 mm, was fixed by means of a chuck so that the weld part comes to the position of chuck end, and the test piece was hit with an impactor at a position 7 mm higher than the weld line (position B in FIG. 14), in the direction of thickness and in a direction parallel to the weld line, to measure the impact strength. On the test piece of Referential Example 1, the whole part up to 12.5 mm from the lower end was fixed with a chuck, a position of 7 mm above the chuck end (position B of FIG. 14) was hit with impactor in the direction of thickness and in the direction parallel to the weld line, to measure the impact strength.

For measurement of impact strength, Dynstat tester (manufactured by Tester Sangyo) shown in FIG. 14 was used, at a test temperature of 23° C. The test was six times repeated on each test piece cut out from each molded product, and the average value was taken as impact strength of the molded product. The results of impact strength measurement are summarized in Table 4.

TABLE 4

| | Impact strength (kJ/m²) | | | | |
|---|---|---|---|---|---|
| | | | Compara- | Compara- | |
| Molding | Example | Example | tive | tive | Referential |
| Material | 1 | 2 | Example 1 | Example 2 | Example 1 |
| A | 22.6 | 23.5 | 2.3 | 8.7 | 20.0 |
| B | 11.3 | 11.1 | 6.8 | 9.8 | — |
| C | 2.4 | 2.4 | 0.9 | 1.8 | — |
| D | 5.4 | 5.3 | 0.9 | 0.9 | — |

The value of impact strength ratio calculated according to the following formula:

(Impact strength in weld part)/

(Impact strength in non-weld part) was determined as

(Average value of impact strength in weld parts in Example 1)/(Average value of impact strength in non-weld part of Referential Example 1).

The results are summarized in Table 5.

TABLE 5

| | A | | |
|---|---|---|---|
| Molding material | Example 1 | Example 2 | Referential Example 1 |
| Impact strength (kJ/m²) | 22.6 | 23.5 | 20.0 |
| Impact strength ratio | 1.13 | 1.18 | — |

It is apparent from Table 4 that the injection molded products obtained according to the process of the present invention (Examples 1 and 2) are much superior in impact strength to the injection molded product of Comparative Example 1 in which no switching of channel was carried out in the injection molding process. It is also apparent that the injection molded products of the present invention are greatly improved in the impact strength in the weld part as compared with the injection product obtained in Comparative Example 2 in which one of the channels was closed after attainment of confluence of molding materials.

Moreover, it is apparent from Table 5 that, when a glass long fiber-reinforced polypropylene (A) was used as the molding material, there was obtained an injection molded product in which impact strength in the weld part was higher than that in the non-weld part.

What is claimed is:

1. A process for producing an injection molded product by making flow a molten material from a cylinder through a plurality of gates provided in a die into a cavity and thereby filling the cavity with the molten material, characterized by decreasing or stopping a flow(s) of the molten material coming from a part of the gates before flows of the molten material coming from a plurality of gates attain confluence in the cavity and making confluent the decreased or stopped flow(s) and a flow(s) of the molten material coming from the residual gate(s).

2. A process according to claim 1, wherein the flow(s) of the molten material coming from a part of the gates is stopped.

3. A process according to claim 1, wherein said cylinder is a single cylinder.

4. A process according to claim 1, wherein the flow(s) of the molten material is decreased or stopped by closing the gate part or a flow channel of the molten material inlet course located in the upstream position of the gate.

5. A process according to claim 4, wherein the method for closing the flow(s) is to close a valve.

6. A process according to any one of claims 1 to 5, wherein said material is a material prepared by compounding a reinforcing material into a thermoplastic resin.

7. A process according to claim 6, wherein said thermoplastic resin is a propylene type resin.

8. A process according to claim 6, wherein said reinforcing material is glass fiber.

9. A process according to any one of claims 1 to 5, wherein said material is a thermotropic liquid crystal polymer.

10. An injection molded product made of one material and having one or a plurality of weld part(s), wherein the ratio (impact strength in the weld part)/(impact strength in the non-weld part) ≧0.95.

11. An injection molded product according to claim 10, wherein said material is a thermoplastic resin compounded with a reinforcing material.

12. An injection molded product according to claim 11, wherein said thermoplastic resin is a propylene type resin.

13. An injection molded product according to claim 11, wherein said reinforcing material is glass fiber.
